(19) United States
(12) Patent Application Publication
(10) Pub. No.: US 2005/0139644 A1
(43) Pub. Date: Jun. 30, 2005

(54) Electronic devices and methods of forming electronic devices

(75) Inventors: Nathaniel E. Brese, Farmingdale, NY (US); Michael P. Toben, Smithtown, NY (US)

Correspondence Address: EDWARDS & ANGELL, LLP, P.O. BOX 55874, BOSTON, MA, 02205, US

(73) Assignee: Rohm and Haas Electronic Materials LLC

(21) Appl. No.: 11/020,406

(22) Filed: Dec. 22, 2004

Related U.S. Application Data
(60) Provisional application No. 60/532,265, filed on Dec. 22, 2003.

(51) Int. Cl. B23K 31/02

(52) U.S. Cl. 228/248.1

(57) ABSTRACT

Disclosed are methods of forming an electronic device. The methods involve (a) providing a substrate and a component to be bonded to the substrate, wherein the component is chosen from an electronic component, an optical component, a device lid, and a combination thereof; (b) applying solder paste to the substrate and/or the component, wherein the solder paste includes a carrier vehicle and a metal portion with metal particles; and (c) bringing the substrate and the component into contact with each other. The solder paste has a solidus temperature lower than the solidus temperature that would result after melting of the solder paste and re-solidification of the melt. Also provided are electronic devices which can be formed by the inventive methods. Particular applicability can be found in the electronics industry in the formation of hermetic electronic device packages, for example, hermetic optoelectronic device packages, formed from semiconductor wafers.

### CROSS-REFERENCE TO RELATED APPLICATIONS

This application claims the benefit under 35 U.S.C. § 119(e) of U.S. Provisional Application No. 60/532,265, filed Dec. 22, 2003, the entire contents of which are incorporated herein by reference.

### BACKGROUND OF THE INVENTION

This invention relates generally to methods of forming electronic devices and to electronic devices that can be formed by the methods. More particularly, the invention relates to methods of forming electronic devices using solder pastes having a lowered solidus temperature, and to electronic devices that include such solder pastes. Particular applicability can be found in the electronics industry in the formation of hermetic electronic device packages, for example, hermetic optoelectronic device packages, formed from semiconductor wafers.

The use of hermetically sealed electronic packages that house one or more electronic, optoelectronic, and/or optical components has been proposed. U.S. Patent Publication No. 2003/0123816, for example, discloses a hermetically sealed optical device package having a substrate that holds on an upper surface thereof an optical signal carrier, i.e., an optical fiber stub, an optical semiconductor component, and other optional components (e.g., a lens, filter, modulator, etc.) interposed between the optical fiber and the optical semiconductor component. A frame is bonded to the substrate upper surface such that the frame opening is over the components and at least a portion of the optical fiber. A lid is bonded to the frame to form an enclosure, together with the lid, forming a cover structure for sealing the components within the enclosure.

Hermetic packages provide for containment and protection of the enclosed devices, which are typically sensitive to environmental conditions. In this regard, degradation in operation of one or more of the components may be caused by atmospheric contaminants such as humidity, dust, and free ions. The optical input/output surfaces of optoelectronic and optical components in the package are especially susceptible to contamination while metallic surfaces of the package are susceptible to corrosion. Both of these effects may give rise to reliability problems. Hermetic sealing of the package to prevent contact with the outside atmosphere is thus desired.

Prior to affixing a lid to the substrate, typically by soldering, the components of the package are first bonded to the substrate. This requires the establishment of a bonding hierarchy in order that a previously bonded component will not be adversely affected by subsequent thermal processing during bonding of other components or processing in general. For example, when a component has been bonded to a substrate by soldering, the solidus temperature of the solder should not be approached during subsequent processing to prevent softening and degradation of the solder connection. It is, however, difficult to produce reliable solder connections using low-melting solders, as they often fatigue or deform (e.g., creep) during operation of the electronic components, resulting in lowered reliability. The bonding hierarchy thus severely limits the types of materials that can be used in bonding components in the electronic device.

Yet a further restriction on the use of solder materials concerns a recent, environmentally-driven lead-free initiative that has increased the need to eliminate lead-containing materials used in the electronics industry, such as eutectic tin-lead alloys. Unfortunately, the best alternatives to lead-containing materials have a higher solidus temperature relative to eutectic tin-lead. Presently, Sn/Ag3.0/Cu0.5 solder paste is under consideration as a replacement for eutectic Sn/Pb. Unfortunately, however, the solidus temperature of the Sn/Ag3.0/Cu0.5 alloy is about 217° C., 34 C.° higher than that of eutectic Sn/Pb. There is concern that the increased thermal excursion required by this alloy may lead to premature failure of the electronic component. Hence, there remains a need to find a suitable replacement for lead-containing alloys having a relatively low solidus temperature.

Another important alloy used in the sealing of optoelectronic devices is SnAu in an 80:20 ratio which has a solidus temperature of 280° C. This alloy is generally applied through evaporation techniques under high vacuum, although its application by electroplating techniques is also possible. When this material is used to seal a hermetic package, materials with even higher solidus temperatures must be used to bond the devices therein. As with the substitution of Sn/Ag3.0/Cu0.5 for eutectic Sn/Pb, these high temperatures can adversely affect the devices within the package. Accordingly, there is a need in the art for bonding materials in general having a relatively low solidus temperature.

The methods and components of the invention can prevent or conspicuously ameliorate one or more of the problems mentioned above with respect to the state of the art.

### SUMMARY OF THE INVENTION

In accordance with a first aspect, the present invention provides methods of forming an electronic device. The methods involve (a) providing a substrate and a component to be bonded to the substrate, wherein the component is chosen from an electronic component, an optical component, a device lid, and a combination thereof; (b) applying solder paste to the substrate and/or the component, wherein the solder paste includes a carrier vehicle and a metal portion with metal particles; and (c) bringing the substrate and the component into contact with each other. The solder paste has a solidus temperature lower than the solidus temperature that would result after melting of the solder paste and re-solidification of the melt.

In accordance with a further aspect, the present invention provides electronic devices. The devices include a substrate and a component on a surface of the substrate. The component is chosen from an electronic component, an optical component, a device lid, and a combination thereof. Solder paste is provided in contact with the substrate and the component. The solder paste includes a carrier vehicle and a metal portion having metal particles. The solder paste has a solidus temperature lower than the solidus temperature that would result after melting of the solder paste and re-solidification of the melt.

Other features and advantages of the present invention will become apparent to one skilled in the art upon review of the following description, claims, and drawings appended hereto.

### BRIEF DESCRIPTION OF THE DRAWINGS

The present invention will be discussed with reference to the following drawing, in which:

FIG. 1 illustrates an exemplary electronic device in accordance with the invention.

### DETAILED DESCRIPTION OF THE INVENTION

The methods of the invention will now be described. As used herein, the terms “a” and “an” mean one or more unless otherwise specified. The term nanoparticle means a particle having a diameter of 50 nm or less. The term “metal” means single-component metals, mixtures of metals, metal-alloys, and intermetallic compounds. The temperature at which the material first begins to melt is referred to as the “solidus temperature”. When talking of one object being “bonded to” or “in contact with” another object, direct as well as indirect bonding or contacting, respectively, are intended. The term “electronic device” encompasses devices having electrical functionality, devices having electrical and optical functionality, i.e., optoelectronic devices, MEMS (micro electrical mechanical system) devices, and the like.

The methods of the invention involve forming an electronic device by applying solder paste to a substrate and/or a component to be bonded to the substrate, and bringing the substrate and the component into contact with each other. The component is chosen from an electronic component, an optical component, a device lid, and a combination thereof.

The solders used in the present invention are formed from a solder paste containing a metal component in the form of metal particles and a carrier vehicle component. The size of the metal particles is chosen such that the solder paste has a solidus temperature lower than the solidus temperature would be after melting of the solder paste and resolidification of the melt.

The invention is based on the principle that metal nanoparticles have a lower solidus temperature than their larger-sized counterparts used in conventional solder pastes, which have the same solidus temperature as the bulk metal. The solidus temperature of the metal can be reduced incrementally by incremental reductions in particle size below a threshold value. Once melted and solidified, the resulting metal possesses the solidus temperature of the resolidified melt/bulk material. When incorporated in a solder paste, the nanoparticles are, in the same manner, effective to reduce the solidus temperature of the solder paste in comparison to the subsequently melted and solidified material. As a result, it is possible to form solder areas at a given temperature which do not reflow during subsequent heat treatment processes at that same (or even higher) temperatures. This allows for significant flexibility in the bonding sequence and hierarchy of an electronic component, as well as in the choice of solder paste and other device materials.

Further, the metal particles used may result in the reduction or elimination of organic residues that may remain after reflow of the solder paste when organic components are used in the solder paste. While not wishing to be bound by any particular theory, it is believed that the relatively high surface area of the metal particles in the solder paste may increase the catalytic rate of decomposition of the organic materials.

While the effective size of the metal particles will depend, for example, on the particular metal and the desired solidus temperature of the solder paste, useful particles are generally in the nanometer-size range. Nanoparticles can be produced by a variety of known techniques, for example, chemical vapor deposition (CVD), physical vapor deposition (PVD) such as sputtering, electrolytic deposition, laser decomposition, arc heating, high-temperature flame or plasma spray, aerosol combustion, electrostatic spraying, templated electrodeposition, precipitation, condensation, grinding, and the like. International publication No. WO 96/06700, for example, the entire contents of which are incorporated herein by reference, discloses techniques for forming nanoparticles from a starting material by heating and decomposition of a starting material using an energy source, such as a laser, electric arc, flame, or plasma.

The metal particles useful in the present invention include, for example, tin (Sn), lead (Pb), silver (Ag), bismuth (Bi), indium (In), antimony (Sb), gold (Au), nickel (Ni), copper (Cu), aluminum (Al), palladium (Pd), platinum (Pt), zinc (Zn), germanium (Ge), lanthanides, combinations thereof, and alloys thereof. Of these, Sn, Pb, Ag, Bi, In, Au, Cu, combinations thereof, and alloys thereof, are typical, for example, tin and tin-alloys, such as Sn—Pb, Sn—Au, Sn—Ag, Sn—Cu, Sn—Ag—Cu, Sn—Bi, Sn—Ag—Bi, and Sn—In. More particularly, Sn—Pb37, Sn—Pb95, Sn—Au20, Sn—Ag3.5, Sn/Ag3.0/Cu0.5 (wt % based on the metal component), and the like find use in the invention.

The metal particle size and size distribution in the solder paste can be selected to provide a desired solidus temperature, which will depend, for example, on the type(s) of particles. For example, the particle size and distribution can be selected to provide a solidus temperature for the solder paste that is 3 or more C.° lower, for example, 5 or more C.° lower, 10 or more C.° lower, 50 or more C.° lower, 100 or more C.° lower, 200 or more C.° lower, 400 or more C.° lower, or 500 or more C.° lower than the resulting solidus temperature would be after melting of the solder paste and resolidification of the melt.

The metal particles are typically present in the solder paste in an amount greater than 50 wt %, for example, greater than 85 wt %, based on the solder paste. As set forth above, the particle size effective to lower the solidus temperature of the metal particles and resulting solder paste will depend on the particular type(s) of particle material. Generally, it will be sufficient if 50% or more of the particles, for example, 75% or more, 90% or more, or 99% or more, have a diameter of 50 nm or less, for example, 30 nm or less, 20 nm or less, or 10 nm or less. Generally, the average diameter of the metal and/or metal-alloy particles is 50 nm or less, for example, 30 nm or less, 20 nm or less, or 10 nm or less. Typically, the size and size distribution of the metal particles is effective to allow melting of the solder paste at a lower temperature than the solidus temperature of the solidified melt. However, it may be sufficient if a percentage of the particles are of a larger size that do not melt, assuming the resulting solder area provides a sufficiently reliable electrical connection in the electronic component. A portion of the larger particles may dissolve into the melted portion of the solder paste.

The carrier vehicle can contain one or more components, for example, one or more of a solvent, a fluxing agent, and an activator. The carrier vehicle is typically present in the solder paste in an amount of from 1 to 30 wt %, for example, from 5 to 15 wt %.

A solvent is typically present in the carrier vehicle to adjust the viscosity of the solder paste, which is typically from 100 kcps (kilocentipoise) to 2,000 kcps, for example, from 500 to 1,500 kcps or from 750 to 1,000 kcps. Suitable solvents include, for example, organic solvents, such as low molecular weight alcohols, such as ethanol, ketones, such as methyl ethyl ketone, esters, such as ethyl acetate, and hydrocarbons, such as kerosene. The solvent is typically present in the carrier vehicle in an amount of from 10 to 50 wt %, for example, from 30 to 40 wt %.

A fluxing agent can further be included in the carrier vehicle to enhance adhesion of the solder paste to the contacting surfaces. Suitable fluxing agents include, for example, one or more rosins such as polymerized rosins, hydrogenated rosins, and esterified rosins, fatty acids, glycerine, or soft waxes. When used, the fluxing agent is typically present in the carrier vehicle in an amount of from 25 to 80 wt %. In the case of optical or optoelectronic components, it may be desired to avoid the use of fluxing agents as optical surfaces might become coated with those components or their breakdown byproducts. This may give rise to optical loss and light transmission problems in the system. In certain cases, the use of a reducing atmosphere eliminates the need to use fluxing agents. In this case, the particles may be dispersed in a simple solvent, such as methanol, which evaporates upon heating and leaves little contaminating residue. Clean-burning dispersants such as acrylates are particularly useful in such solder pastes. Activators help to remove oxide formed on the surfaces in contact with the solder paste and/or on the surface of the metal particles when the solder paste is heated. Suitable activators are known in the art, and include, for example, one or more organic acid, such as succinic acid or adipic acid and/or organic amine, such as urea, other metallic chelators, such as EDTA, halide compounds, such as ammonium chloride or hydrochloric acid. When used, the activator is typically present in the carrier vehicle in an amount of from 0.5 to 10 wt %, for example, from 1 to 5 wt %.

Additional additives may optionally be used in the solder paste, for example, thixotropic agents, such as hardened castor oil, hydroxystearic acid, or polyhydridic alcohols. The optional additives are typically present in the solder paste in an amount of from 0 to 5 wt %, for example, from 0.5 to 2.0 wt %.

To reduce the possibility of corrosion of the formed electronic components and the associated problems, the solder paste may be substantially free of halogen and alkali metal atoms. Typically, the halogen and alkali metal atom content in the solder is less than 100 ppm, for example, less than 1 ppm.

The solder pastes in accordance with the invention can be formed by blending the metal component with the carrier vehicle components, including any desired optional components. The non-metal components may be blended first to provide a more uniform dispersion.

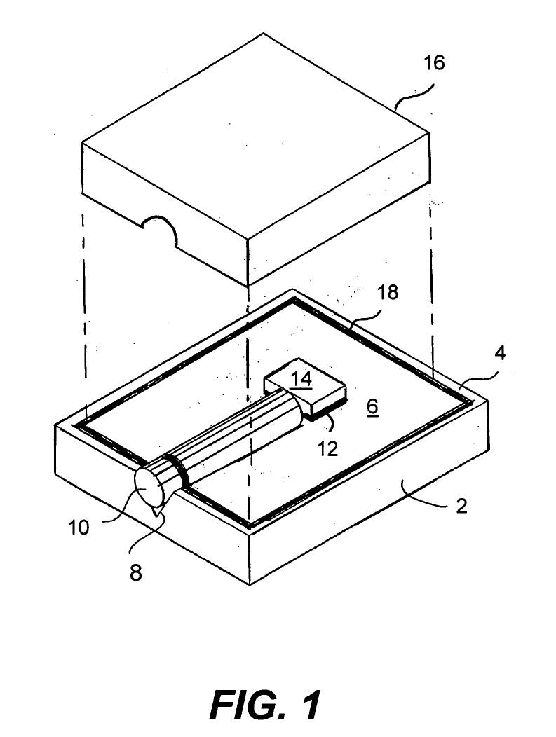

FIG. 1 illustrates an exemplary electronic device 2 in accordance with the invention. While the exemplified device is an optoelectronic device, the invention applies also to electronic devices having no optical functionality, for example, a high frequency signal detector which is used in harsh environments, such as automotive, aerospace, or medical applications.

A substrate 4 is provided with one or more surface features formed in or on a surface thereof for holding one or more electronic and/or optical components. The substrate is typically formed of a material such as silicon, for example, single crystal silicon such as <100> silicon, silicon-on-sapphire (SOS), silicon-on-insulator (SOI), ceramic, polymer or metal. The substrate may be, for example, an optical bench, a glass or ceramic optical flat, or a molded plastic part. Electronic components which may be bonded to the substrate include, for example, integrated circuits (ICs), lasers, light emitting diodes (LEDs), photodetectors, vertical cavity surface emitting lasers (VCSELs), micro optical electrical mechanical devices (MOEMs), thermoelectric coolers, and the like. Suitable optical components include, for example, optical fibers, fiber stubs, lenses, filters, gratings, waveguides, modulators, and the like.

The illustrated electronic device 2 is a hermetic silicon optical bench having a <100> silicon substrate 4 with upper major surface 6, an etched V-groove 8 for receiving an optical fiber stub 10, a solder pad 12 for receiving an electronic component 14, for example, a laser diode, light emitting diode (LED), or a photodetector, and a lid 16 fabricated, for example, from silicon, a ceramic, or glass, for hermetically sealing the device.

One or more of the electronic component 14, the optical fiber 10 or the lid 16 are bonded to the substrate 4 using a solder paste as described above. Those parts not bonded using the solder paste may be bonded using other known materials and techniques. In using the solder paste of the invention, it may be necessary to prepare the surface of the component to be bonded and/or the substrate surface to provide a solderable surface. For example, in the case of a silicon substrate or a silicon lid, the bonding surfaces may be prepared by polishing, cleaning and metallization using sputtering, CVD, or plating techniques. For optical components formed, for example, of glass, ceramic, or polymer, bonding surfaces may be prepared by polishing, cleaning, and application of a pre-treatment solution or a vapor-deposited material. Electronic components are typically made with a solderable finish, for example, electroless nickel immersion gold (ENIG).

The solder paste may be applied to the substrate and/or the component to be bonded prior to bringing the objects into contact with each other. For example, the solder paste may be applied in the V-groove as a fillet or in selected locations along the length of the V-groove and/or fiber to bond the optical fiber 10 in place. The optoelectronic component 14 may be bonded in place by applying the solder paste as a layer on the pad 12 and/or to the device. Finally, the lid 16 may be bonded into place on the substrate 4 by applying the solder paste 18 in a ring-shape around the periphery of the substrate and over the optical fiber 10 at the location of contact between the lid and substrate. Additionally or alternatively, the solder may be applied to the surfaces of the lid 16 which are to contact the substrate. Upon heating, melting and resolidification of the solder paste, a hermetic seal can thus be obtained. Alternatively, the solder paste may be applied to the substrate and component or lid after they are brought into contact with each other. The solder paste may be applied, for example, by screen printing, doctor blading, spray coating, dispensing through a nozzle such as a syringe, or a variety of techniques known in the art. While the amount and thickness of the solder paste used will depend, for example, on the particular solder paste and the component and substrate geometries involved, the solder paste is typically coated to a thickness of from 2 to 400 μm. For bonding of certain components one may wish to use a relatively thin coating such as from 2 to 50 μm, or a relatively thick coating such as 100 to 400 μm.

The substrate is next heated to melt the solder paste. The heating can be conducted, for example, in a reflow oven at a temperature at which the solder paste melts. Suitable heating techniques are known in the art, and include, for example, infrared, direct laser heating, conduction, and convection techniques, and combinations thereof. The heat treatment step can be conducted in an inert gas atmosphere, in a reducing atmosphere, or in air, with the particular process temperature and time being dependent upon the particular composition of the solder paste and size of the metal particles therein. Upon solidification of the melt, a bond is formed between the component and substrate such that the solidified material has a higher solidus temperature than the starting solder paste.

The following prophetic examples are intended to further illustrate the present invention, but are not intended to limit the scope of the invention in any aspect.

### EXAMPLES 1-11

Nanoparticle solder pastes in accordance with the invention are prepared as follows. A 0.25M benzoic acid solution is prepared from 0.92 g of benzoic acid and 20 ml diethyl ether. 86 g of solder alloy nanoparticles are added to the solution and soaked for an hour with occasional stirring. The powder slurry is rinsed and dried. A rosin-based flux is prepared from 50 wt % rosin, 41 wt % glycol solvent, 4 wt % succinic acid, and 5 wt % castor oil. The flux is added to the metal particles to form a paste with 88 wt % metal by weight, as described in Table 1. The resulting solder pastes are used to form solder areas on electronic devices as described below.

A silicon optical bench and the components illustrated in FIG. 1 are provided. Solder paste is applied to the lid using a screen printing technique, and the lid is brought into contact with the silicon optical bench. The solder paste is heated to the expected solidus temperature (Tₛₒₗ) shown in Table 1, thus melting the solder. The solder is allowed to resolidify thereby bonding the lid to the substrate surface. The difference between Tₛₒₗ and the expected solidus temperature of the solder paste after melting and solidification thereof (Tₛₒₗ-T_{bulk}) is also shown in Table 1. As can be seen, significant decreases in the expected solidus temperature can be achieved for a given material by use of nanoparticle solder pastes. Further, the extent of this decrease can be controlled by tuning of the metal particle size.

TABLE 1

| | Metal Component | | | Tₛₒₗ | |
|---|---|---|---|---|---|
| Example | Material | Part. Size (nm) | | (° C.) | Tₛₒₗ₋T_{bulk} (C. °) |
| 1 | Au | 5 | nm | 827 | −100 |
| 2 | Au | 3 | nm | 627 | −300 |
| 3 | Au | 2 | nm | 152 | −639 |
| 4 | Sn | 20 | nm | 227 | −5 |
| 5 | Sn | 5 | nm | 207 | −25 |
| 6 | Al | 2 | nm | 527 | −140 |
| 7 | In | 15 | nm | 144 | −13 |
| 8 | Pb | 15 | nm | 317 | −10 |
| 9 | 63Sn/37Pb | 10 | nm | 170 | −13 |
| 10 | 80Au/20Sn | 15 | nm | 270 | −10 |
| 11 | 80Au/20Sn | 5 | nm | 200 | −80 |

### EXAMPLES 12-21

Flux-free nanoparticle solder pastes in accordance with the invention are prepared as follows. A solution containing low molecular weight polyacrylic acid is prepared from 0.36 g of polyacrylic acid and 20 ml ethanol. 20 g of solder alloy nanoparticles are added to the solution and soaked for an hour with occasional stirring. The powder slurry is rinsed and dried. The solder paste is formulated by mixing 85 parts metal by weight with 15 parts solvent, such as methyl ethyl ketone, ethyl acetate, or methanol, as described in Table 2. The resulting solder pastes are used to form solder areas on electronic devices as described below.

A silicon optical bench and the components illustrated in FIG. 1 are provided. An optical fiber is placed into the V-groove fabricated in the silicon optical bench and held in place using a mechanical holder. Solder paste is applied to the fiber by dispensing through a nozzle. The solder paste is heated to the expected solidus temperature (Tₛₒₗ) shown in Table 2, thus melting the solder. The solder is allowed to resolidify thereby bonding the optical fiber to the silicon optical bench, and the mechanical holder is removed. The difference between Tₛₒₗ and the expected solidus temperature of the solder paste after melting and solidification thereof (Tₛₒₗ-T_{bulk}) is also shown in Table 2. As can be seen, significant decreases in the expected solidus temperature can be achieved for a given material by use of nanoparticle solder pastes. Further, the extent of this decrease can be controlled by tuning of the metal particle size.

TABLE 2

| | Metal Component | | | Tₛₒₗ | |
|---|---|---|---|---|---|
| Example | Material | Part. Size (nm) | | (° C.) | Tₛₒₗ₋T_{bulk} (C. °) |
| 12 | Au | 5 | nm | 827 | −100 |
| 13 | Au | 3 | nm | 627 | −300 |
| 14 | Au | 2 | nm | 152 | −639 |
| 15 | Sn | 20 | nm | 227 | −5 |
| 16 | Sn | 5 | nm | 207 | −25 |
| 17 | In | 15 | nm | 144 | −13 |
| 18 | Pb | 15 | nm | 317 | −10 |
| 19 | 63Sn/37Pb | 10 | nm | 170 | −13 |
| 20 | 80Au/20Sn | 15 | nm | 270 | −10 |
| 21 | 80Au/20Sn | 5 | nm | 200 | −80 |

While the invention has been described in detail with reference to specific embodiments thereof, it will be apparent to one skilled in the art that various changes and modifications can be made, and equivalents employed, without departing from the scope of the claims.

1. A method of forming an electronic device, comprising:
(a) providing a substrate and a component to be bonded to the substrate, wherein the component is chosen from an electronic component, an optical component, a device lid, and a combination thereof;
(b) applying solder paste to the substrate and/or the component, wherein the solder paste comprises a carrier vehicle and a metal portion comprising metal particles; and
(c) bringing the substrate and the component into contact with each other,
wherein the solder paste has a solidus temperature lower than the solidus temperature that would result after melting of the solder paste and re-solidification of the melt.

2. The method of claim 1, wherein 50% or more of the particles have a diameter of 50 nm or less.

3. The method of claim 1, wherein the average diameter of the metal and/or metal-alloy particles is 30 nm or less.

4. The method of claim 1, wherein the solder paste is a fluxless solder paste.

5. The method of claim 1, wherein the solidus temperature of the solder paste is 3 or more ° C. lower than the solidus temperature that would result after melting of the solder paste and re-solidification of the melt.

6. The method of claim 5, wherein the solidus temperature of the solder paste is 10 or more ° C. lower than the solidus temperature that would result after melting of the solder paste and re-solidification of the melt.

7. The method of claim 1, further comprising:
(c) heating the solder paste at a temperature effective to melt the solder paste; and
(d) solidifying the melt.

8. The method of claim 1, wherein (c) is conducted prior to (b).

9. The method of claim 1, wherein the electronic device is hermetically sealed, and the component is a device lid.

10. The method of claim 9, wherein the electronic device is an optoelectronic device comprising an optoelectronic component and one or more optical components bonded to the substrate.

11. The method of claim 1, wherein the component is an optical fiber.

12. An electronic device, comprising:
a substrate;
a component on a surface of the substrate, wherein the component is chosen from an electronic component, an optical component, a device lid, and a combination thereof; and
solder paste in contact with the substrate and the component, wherein the solder paste comprises a carrier vehicle and a metal portion comprising metal particles, and wherein the solder paste has a solidus temperature lower than the solidus temperature that would result after melting of the solder paste and re-solidification of the melt.

13. The electronic device of claim 12, wherein 50% or more of the particles have a diameter of 50 nm or less.

14. The electronic device of claim 12, wherein the average diameter of the metal and/or metal-alloy particles is 30 nm or less.

15. The electronic device of claim 12, wherein the solder paste is a fluxless solder paste.

16. The electronic device of claim 12, wherein the solidus temperature of the solder paste is 3 or more C.° lower than the solidus temperature that would result after melting of the solder paste and resolidification of the melt.

17. The electronic device of claim 16, wherein the solidus temperature of the solder paste is 10 or more C.° lower than the solidus temperature that would result after melting of the solder paste and re-solidification of the melt.

18. The electronic device of claim 12, wherein the electronic device is hermetically sealed.

19. The electronic device of claim 18, wherein the component is a lid.

20. The electronic device of claim 19, wherein the substrate and the lid are formed of single crystal silicon.
